(19) United States
(12) Patent Application Publication
(10) Pub. No.: US 2009/0061396 A1
(43) Pub. Date: Mar. 5, 2009

(54) Crochet Stitch/Pattern

(76) Inventor: Ulrike Viviane Fischer, Berlin (DE)

Correspondence Address: Ulrike Fischer, Kollwitzstr. 10, Berlin, 10405, DE

(21) Appl. No.: 12/023,212

(22) Filed: Apr. 7, 2008

(30) Foreign Application Priority Data
Aug. 29, 2007 (EM) 000780796-0001
Aug. 29, 2007 (EM) 000780796-0002
Aug. 29, 2007 (EM) 000780796-0003
Jan. 2, 2008 (CH) 2008-00002

(51) Int. Cl. G09B 19/20; D05B 97/00

(52) U.S. Cl. 434/95; 112/416

(57) ABSTRACT

The present invention relates to a new method for creating crocheted items using a classical crochet hook to form stitches in a new pattern. The pattern produces a visually very attractive surface (on both front and back side) and leads to a specific thickness and density of the produced items which makes them keep their shape very well. The new crocheting method can be applied to a variety of materials producing items especially in the fields of garments and home accessories. The present invention is described in one basic version and two variations.

### CROSS REFERENCE TO RELATED APPLICATIONS

U.S. Pat. No. 5,445,092 Crochet stitch which simulates a whip stitch with reference to U.S. Pat. No. 420,191 January 1890 Fefel U.S. Pat. No. 455,190 June 1891 Fefel U.S. Pat No. 476,455 June 1892 Fefel U.S. Pat. No. 582,314 May 1897 Plumley U.S. Pat. No. 681670 September 1901 Allen U.S. Pat. No. 681,671 September 1901 Allen U.S. Pat. No. 817,475 April 1906 Durand U.S. Pat. No. 832,740 October 1906 Maier U.S. Pat. No. 982,717 January 1911 Grieb U.S. Pat. No. 1,020,944 March 1912 Carter U.S. Pat. No. 1,125,437 January 1915 Avis U.S. Pat. No. 1,602,408 October 1926 Grieb et al. U.S. Pat No. 2,091,760 August 1937 Kelso U.S. Pat. No. 3,090,963 May 1963 Wittman

### PREAMBLE

The present invention relates to a new method for creating crocheted fabric items, in particular garments and home accessories. A classical crochet hook is used to form stitches in a non-traditional way in order to create a fabric of a new visual appearance and a specific thickness and density.

### SUMMARY OF THE INVENTION

Creating a crocheted fabric, in particular garments with a crochet hook is a popular hobby. A wide variety of traditional stitches exists.

The present invention shows a new crocheting method which creates a pattern to be used for garments, home accessories and other application options with both a visually very attractive surface and a specific thickness and density which makes the produced items keep their shape very well.

The crochet pattern according to the invention in its first version is visually defined by consisting on the front view in vertical legs of yarn or other thread like materials which are connected to one another by mainly two prominent horizontal legs. In its back view the vertical legs are seen as diagonals and a third horizontal leg can be seen.

A second version of the pattern shows similar vertical legs, the two horizontal legs are split up into a lower and an upper leg, forming a honey comb view. The back view of the second version shows a line of spiry horizontal legs connected by diagonal legs.

A third version of the pattern shows a line of spiry vertical legs, connected by two horizontal legs and one diagonal leg. The backview of this version shows a line of spiry vertical legs connected by several almost horizontal legs.

### DESCRIPTION OF THE DRAWINGS

FIG. 1 shows the front view of the crochet pattern in its first version according to the invention at the stage 1-(b) where the yarn is being wrapped around the hook from front to back.

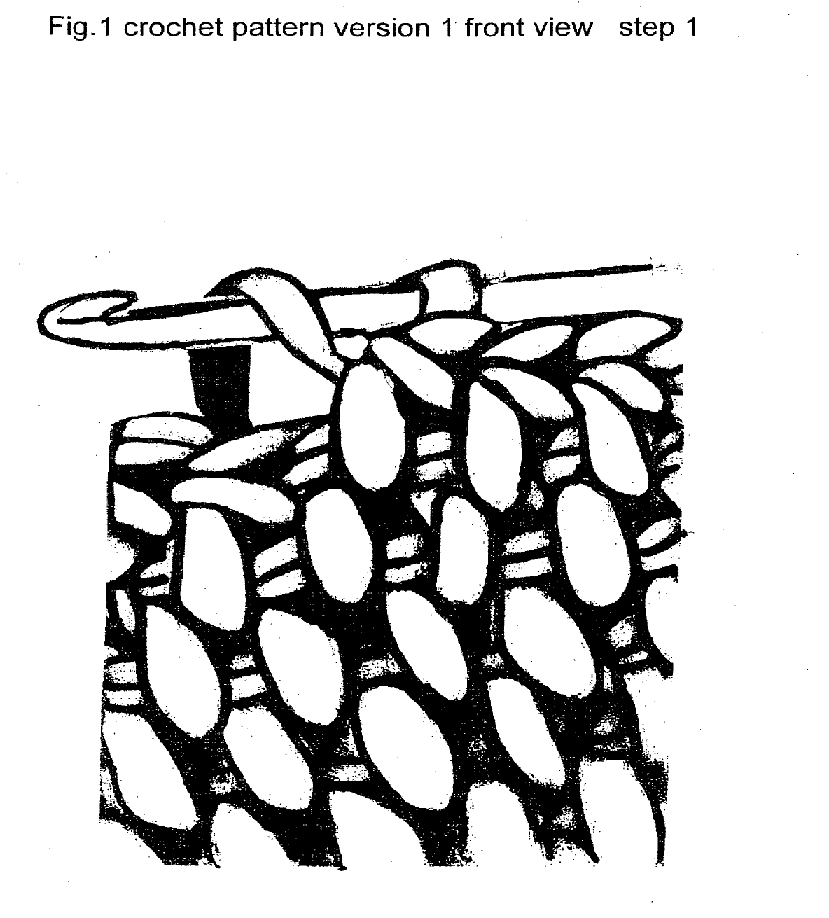

FIG. 2 shows the front view of the crochet pattern in its first version according to the invention at the stage 1-(h) where the hook is inserted into the wide gap between the two vertical legs of the precedent row and under the three horizontal legs of the current row. The arrow in the drawing indicates that after insertion the yarn shall be grabbed with the hook from front to back 1-(d) and pulled through the gap to the front 1-(e).

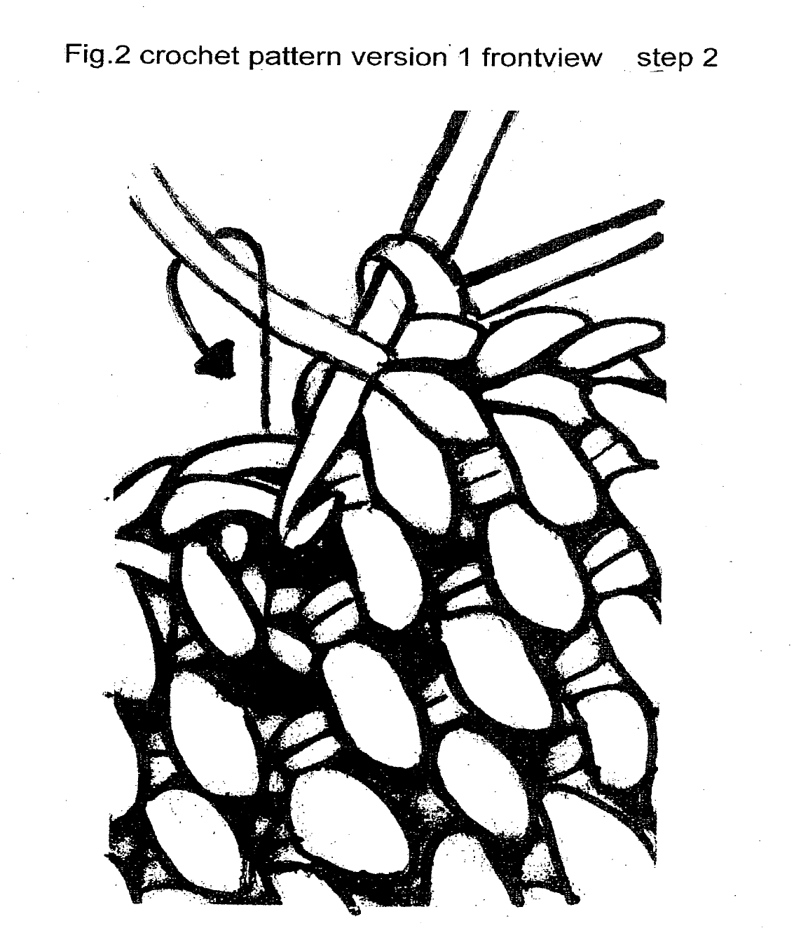

FIG. 3 shows the front view of the crochet pattern in its first version according to the invention at the stage 1-(f) where the yarn has been wrapped around the hook from back to front. The arrow indicates that the yarn shall be pulled through the three loops on the hook 1-(g).

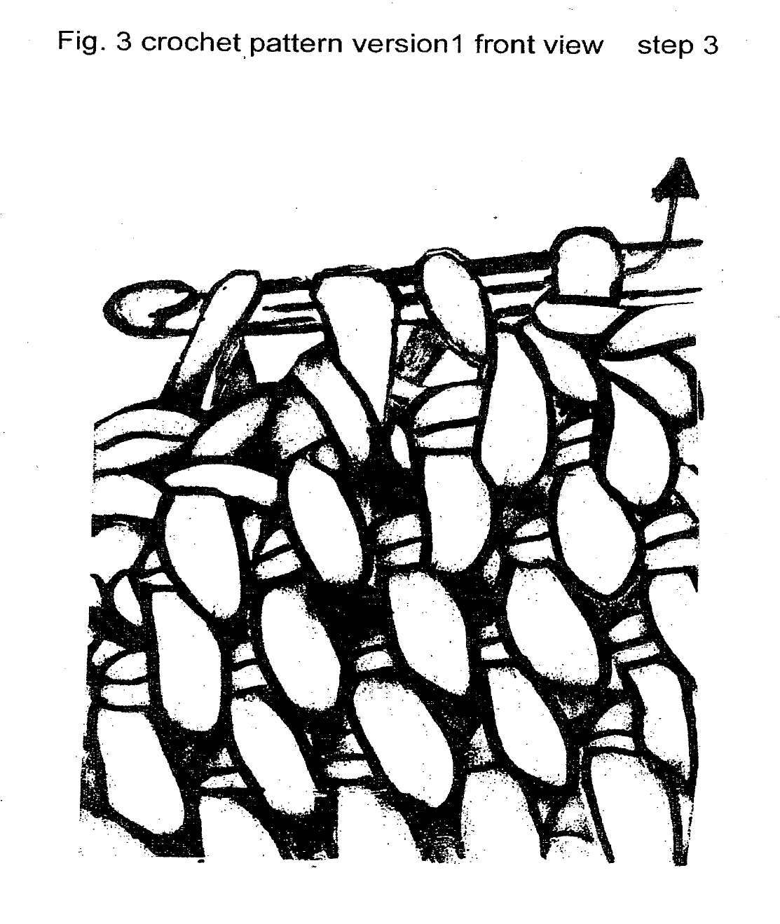

FIG. 4 shows a backview of the crochet pattern in its first version according to the invention.

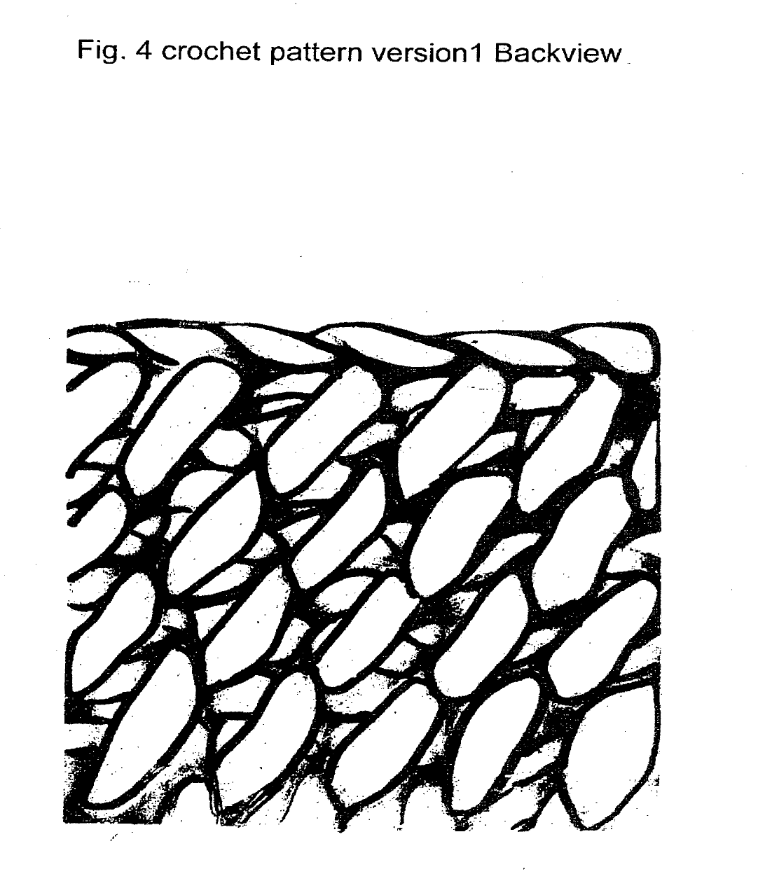

FIG. 5 shows the front view of the crochet pattern in its second version according to the invention at the stage 2-(b) where the yarn is being wrapped around the hook from front to back

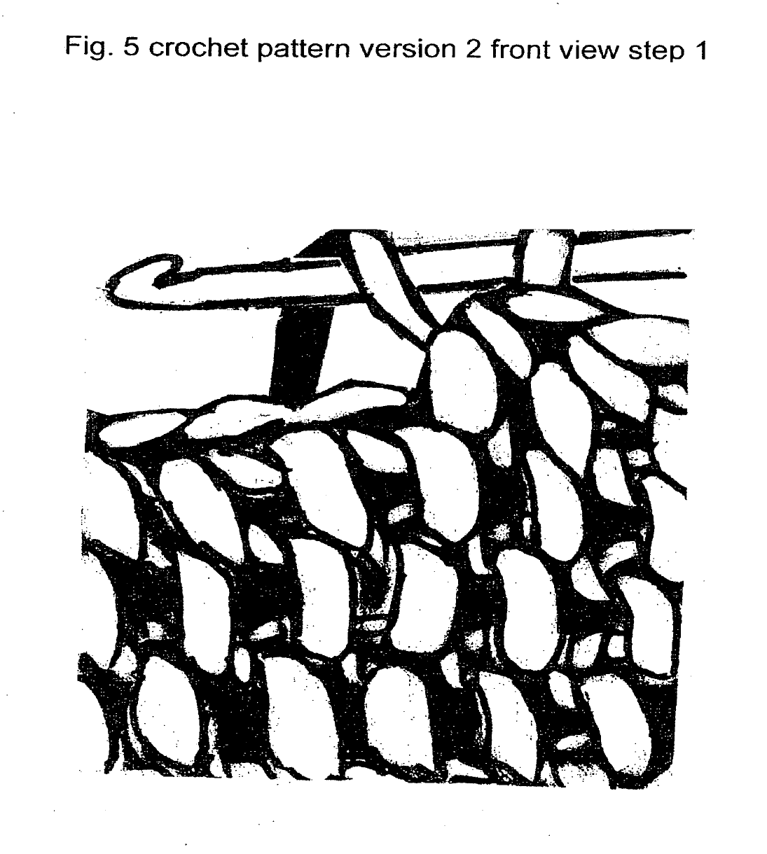

FIG. 6 shows the front view of the crochet pattern in its second version according to the invention at the stage 2-(h) where the hook is inserted into the small gap between the two vertical legs of the precedent row and under the top two horizontal legs of the current row. The arrow in the drawing indicates that after insertion the yarn shall be grabbed with the hook from front to back 2-(d) and pulled through the gap to the front 2-(e).

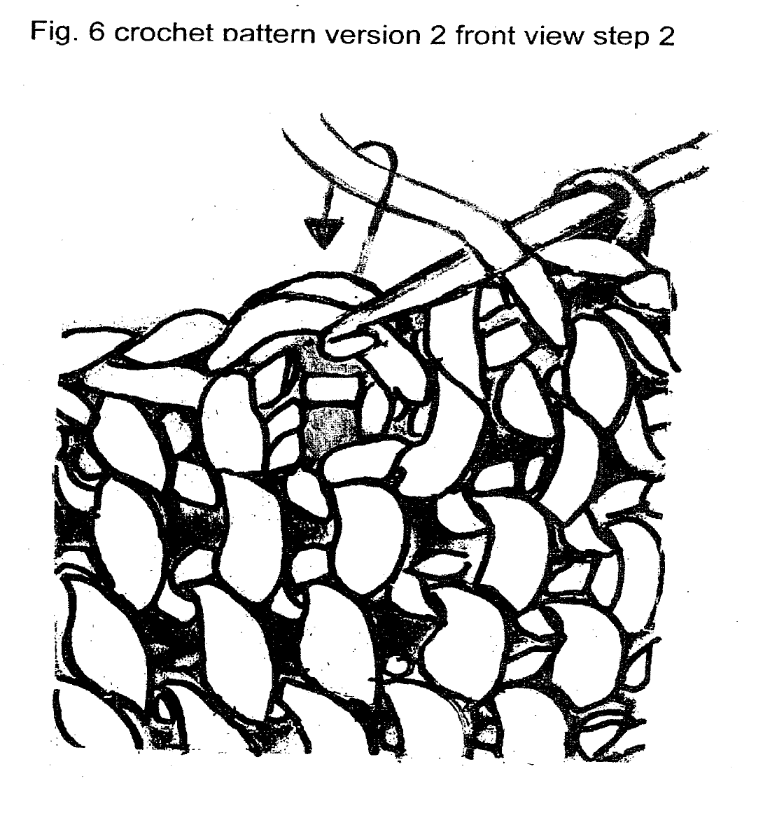

FIG. 7 shows the front view of the crochet pattern in its second version according to the invention at the stage 2(f) where yarn has been wrapped around the hook from back to front. The arrow indicates that the yarn shall be pulled through the three loops at the hook 2-(g).

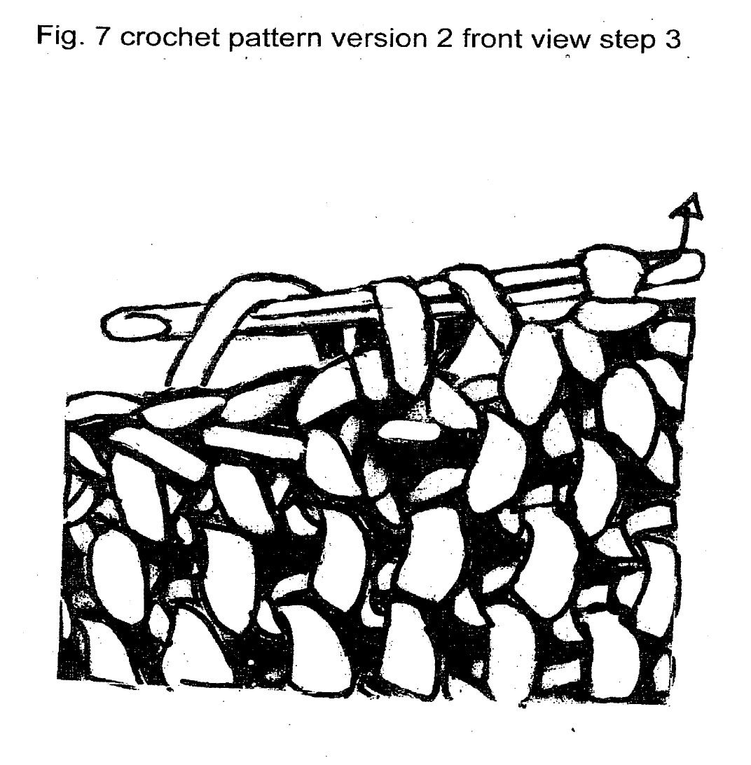

FIG. 8 shows a backview of the crochet pattern in its second version according to the invention

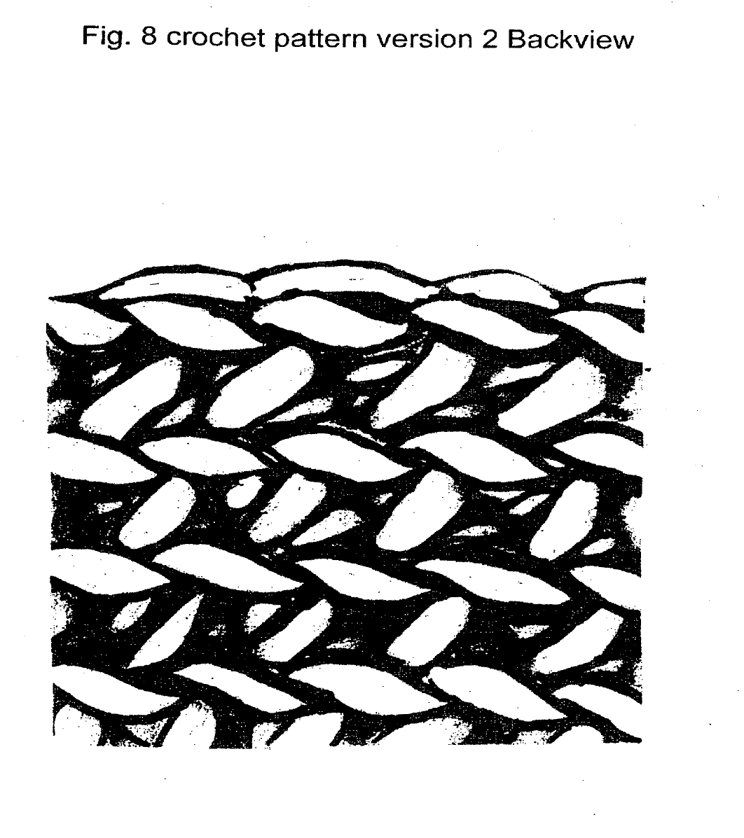

FIG. 9 shows the front view of the crochet pattern in its third version according to the invention at the stage 3-(b) where the yarn is being wrapped around the hook from front to back

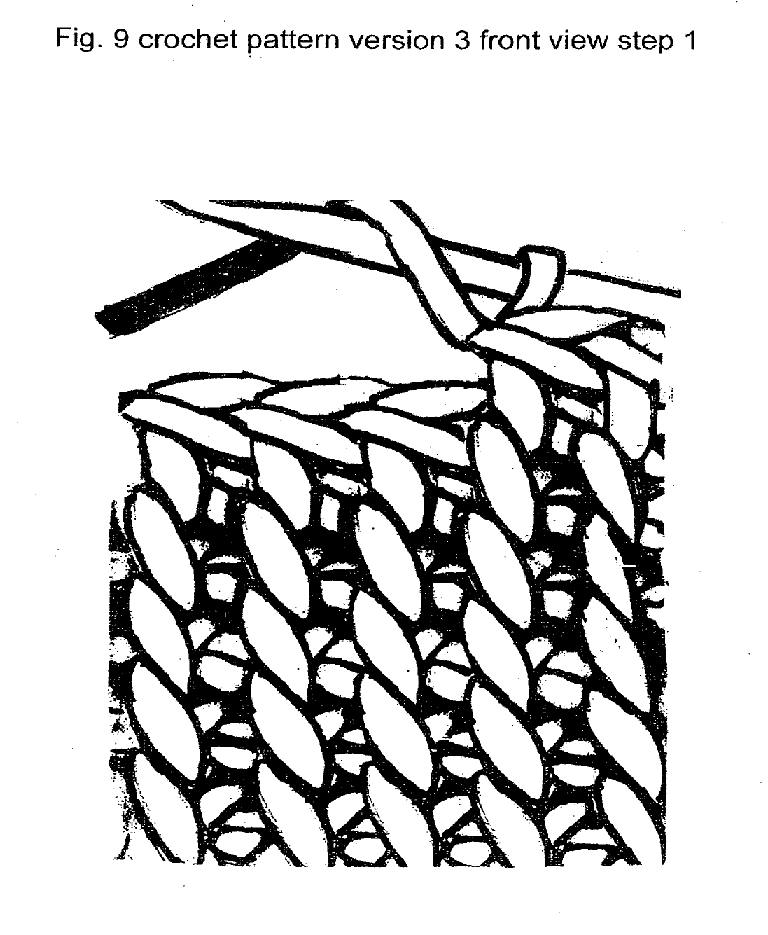

FIG. 10 shows the front view of the crochet pattern in its third version according to the invention at the stage 3-(h) here the hook is inserted but in between the two vertical legs of the precedent row, the front leg being pushed to the left by the insertion of the crochet hook. The arrow in the drawing indicates that after the insertion the yarn shall be grabbed with the hook from front to back 3-(d) and pulled through the gap to the front 3-(e).

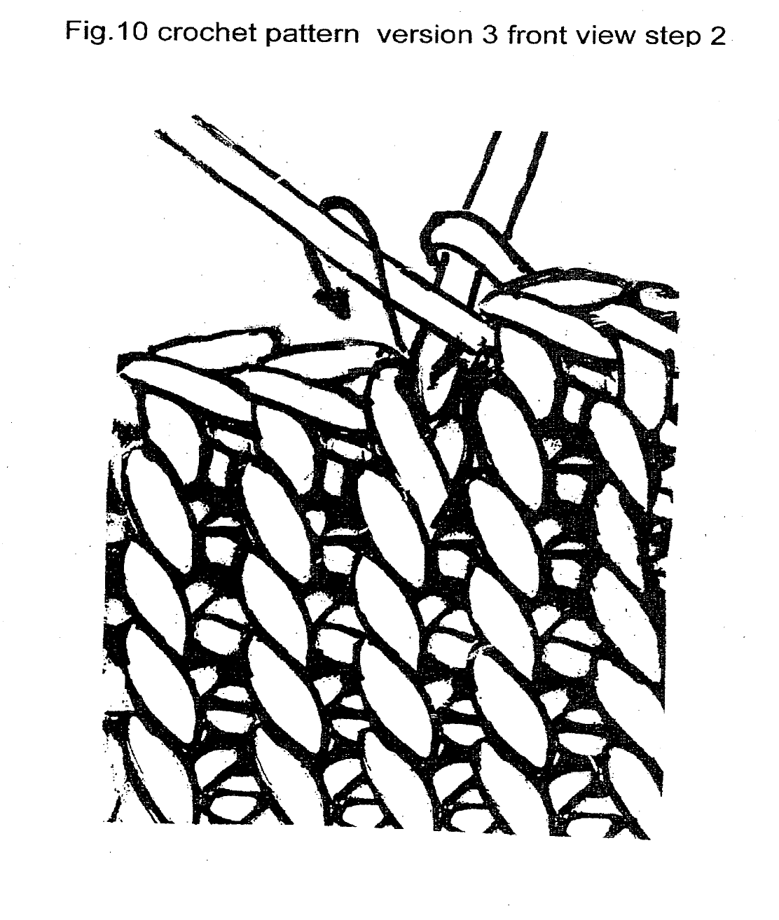

FIG. 11 shows the front view of the crochet pattern in its third version according to the invention at the stage 3-(f) where yarn has been wrapped around the hook from back to front. The arrow indicates that the yarn shall be pulled through the three loops at the hook 3-(g).

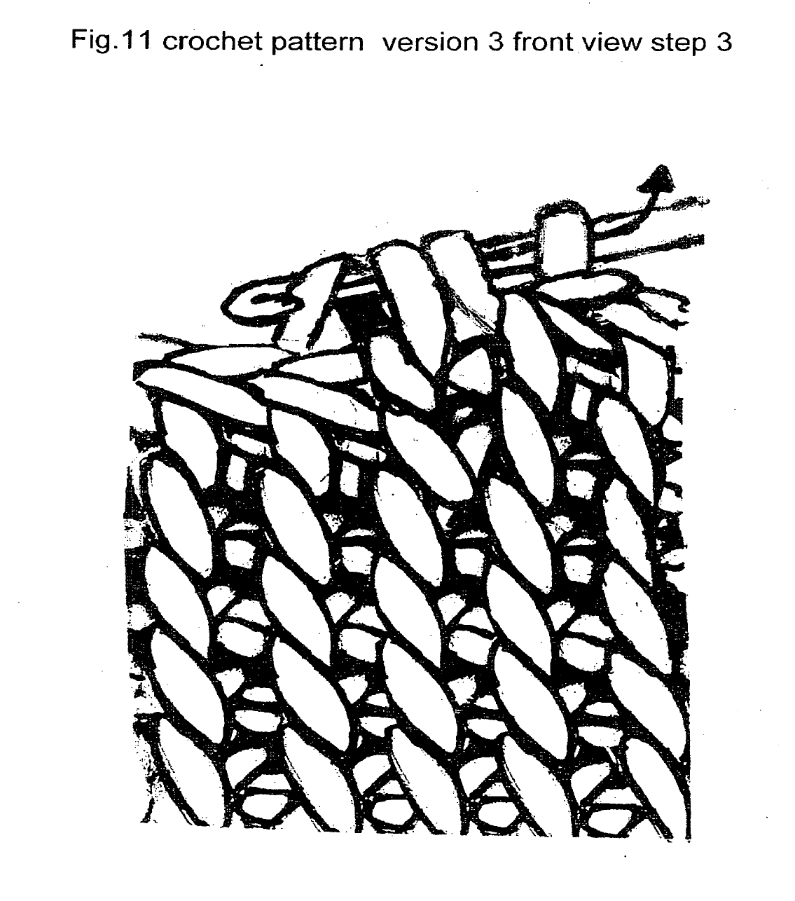

FIG. 12 shows a backview of the crochet pattern in its third version according to the invention

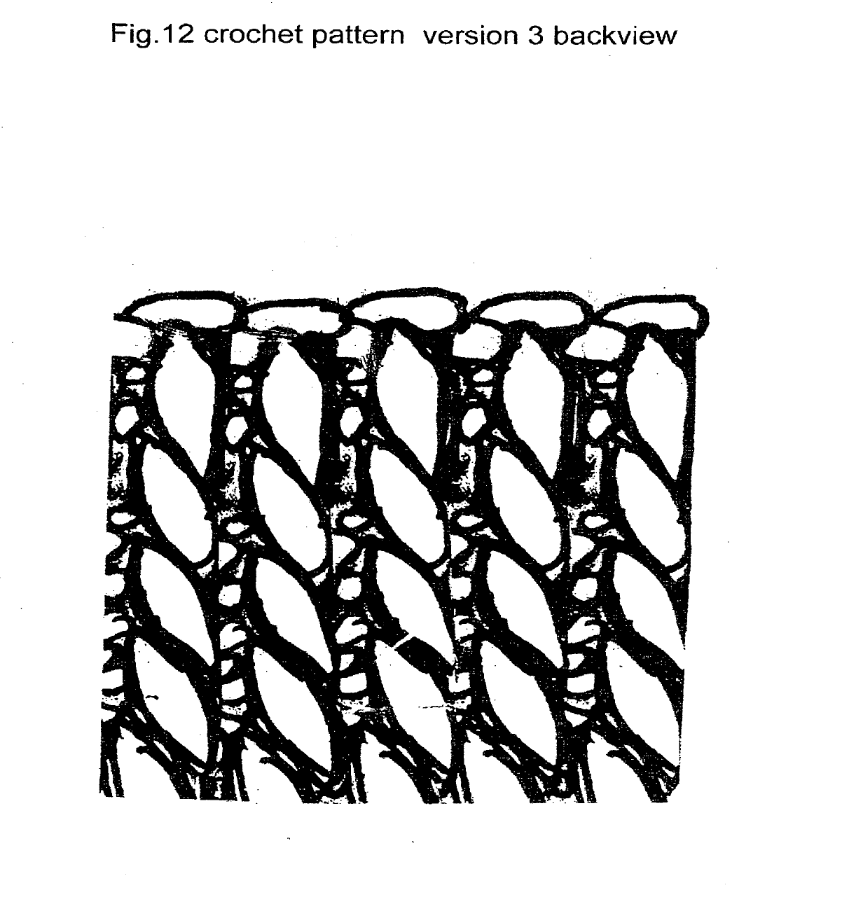

Persons familiar with the art will also realize that the invention may be practiced in various additional ways other than those specifically described in this specification.

For example in order to create round or diagonal shapes for designing garments etc. stitches of the pattern can be added or taken off by making e.g. two stitches into one gap than just one respectively joining two stitches together (in the latter case the step (b) of all above crochet pattern versions is left out for the second stitch). The usage of these shaping methods which do not affect the overall visual impression of the new crochet pattern and its specific characteristics shall be included into the above claims.

Therefore, it is emphasized that the invention is not limited only to the disclosed embodiment but is embracing of variations thereto and improvements thereof which fall within the spirit of the above claims.

I claim:

1. A crochet pattern for a fabric having a first side (front view), a second side (back view) and edges, created by using the following steps—version 1:
(a) forming a chain of chain stitches (foundation chain)
(b) wrapping the yarn from front to back around the hook
(c) inserting the hook in the centre of a chain stitch
(d) grabbing the yarn with the hook from front to back
(e) pulling the yarn through (three loops on the hook)
(f) wrapping the yarn from back to front around the hook
(g) pulling it through the three loops on the hook
(h) the steps described at (b)-(h) are successively repeated, except that from the second row on the hook is inserted not into the stitches of the foundation chain but into the wide gap between the two vertical legs of the precedent row and under the three horizontal legs of the current row

2. A crochet pattern for a fabric having a first side (front view), a second side (back view) and edges, created by using-the following steps—version 2, see step 2-(h):
(a) forming a chain of chain stitches (foundation chain)
(b) wrapping the yarn from front to back around the hook
(c) inserting the hook in the centre of a chain stitch
(d) grabbing the yarn with the hook from front to back
(e) pulling the yarn through (three loops on the hook)
(f) wrapping the yarn from back to front around the hook
(g) pulling it through the three loops on the hook
(h) the steps described at (b)-(h) are successively repeated, except that from the second row on the hook is inserted not into the stitches of the foundation chain but into the small gap between the two vertical legs of the precedent row and under the two top legs of the current row

3. A crochet pattern for a fabric having a first side (front view), a second side (back view) and edges, created by using the following steps—version 3, see step 3-(h):
(a) forming a chain of chain stitches (foundation chain)
(b) wrapping the yarn from front to back around the hook
(c) inserting the hook in the centre of a chain stitch
(d) grabbing the yarn with the hook from front to back
(e) pulling the yarn through (three loops on the hook)
(f) wrapping the yarn from back to front around the hook
(g) pulling it through the three loops on the hook
(h) the steps described at (b)-(b) are successively repeated, except that from the second row on the hook is inserted not into the stitches of the foundation chain but in between the two vertical legs of the precedent row, the front leg being pushed to the left by the insertion of the crochet hook.
